(19) United States
(12) Patent Application Publication
(10) Pub. No.: US 2025/0158017 A1
(43) Pub. Date: May 15, 2025

(54) MAGNESIUM SECONDARY BATTERY AND METHOD FOR MANUFACTURING MAGNESIUM SECONDARY BATTERY

(71) Applicant: THE FURUKAWA BATTERY CO., Ltd., Yokohama-shi (JP)

(72) Inventor: Naoki TAKEGUCHI, Fukushima (JP)

(73) Assignee: THE FURUKAWA BATTERY CO., Ltd., Yokohama-shi (JP)

(21) Appl. No.: 18/928,279

(22) Filed: Oct. 28, 2024

(30) Foreign Application Priority Data
Nov. 13, 2023 (JP) 2023-192677

(51) Int. Cl. H01M 4/04; H01M 4/02; H01M 4/46

(52) U.S. Cl. CPC H01M 4/0445; H01M 4/466; H01M 2004/027

(57) ABSTRACT

A magnesium secondary battery includes: a positive electrode; a negative electrode having a magnesium layer made of a eutectic magnesium alloy; a separator; and an electrolytic solution, in which in powder X-ray diffraction measurement of the negative electrode using a CuKα ray, when an intensity ratio Y obtained from a diffraction peak representing a (100) plane within a range of 2θ=32°±5° and a diffraction peak representing a (002) plane within a range of 2θ=35°±5° is defined as a diffraction peak intensity ratio of (100)/(002), 15<Y is satisfied.

### CROSS-REFERENCE TO RELATED APPLICATION(S)

This application claims the benefit of priority from Japanese Patent Application No. 2023-192677 filed on Nov. 13, 2023, the entire contents of which are incorporated herein by reference.

### BACKGROUND

### 1. Technical Field

The present disclosure relates to a magnesium secondary battery and a method for manufacturing the magnesium secondary battery.

### 2. Related Art

In recent years, environmental problems have become serious problems. Therefore, natural energy power generation is desired from a viewpoint of environmental load. However, supply of natural energy is unstable, and electric energy generated once needs to be stored. Therefore, it is required to increase a capacity of a power storage device such that such large electric energy can be stored.

Currently, a lithium ion secondary battery and a magnesium secondary battery are known as power storage devices. Among these batteries, the magnesium secondary battery is attracting attention as a battery in which a high energy density is expected because a carrier is a divalent magnesium ion. In addition, magnesium metal is stable in air and has a theoretical capacity per volume of about 1.5 times as compared with lithium metal, and thus is required to be put into practical application as a metal secondary battery using magnesium metal for a negative electrode.

However, in a hexagonal close-packed (hcp) structure which is a crystal structure of magnesium, since a (001) plane which is a bottom surface portion is an electrochemically inactive plane, a reversible dissolution precipitation reaction is not exhibited during charging and discharging, and it is difficult to put the magnesium secondary battery into practical application.

Therefore, JP 5304961 B2 describes that two phases of a body-centered cubic structure and a hexagonal close-packed structure coexist by inclusion of lithium in a magnesium alloy. A state in which lattice structures coexist may be referred to as a eutectic state, although there is no such description in JP 5304961 B2. It is considered that since the body-centered cubic structure has a lower atom filling ratio than the hexagonal close-packed structure, magnesium ions are smoothly inserted into and extracted from a bulk, and as a result, charging and discharging characteristics are improved, and overvoltage at the time of dissolution and precipitation of magnesium is reduced.

### SUMMARY

However, different crystal structures are mixed in a material in a eutectic state. Therefore, an electrochemically active surface is partially exposed in the vicinity of a grain boundary where the different crystal structures are adjacent to each other on an electrode surface. When a current is concentrated at the portion where the active surface is partially exposed, magnesium to be electrodeposited is precipitated in a tower shape, and penetrates a separator to cause internal short circuit. This is a problem that does not occur in other magnesium metal negative electrodes, and is a major disadvantage of the material when compared with other magnesium metal negative electrodes.

The disclosure has been made in view of the above problems, and it is desirable to provide a magnesium secondary battery capable of suppressing occurrence of internal short circuit while reducing overvoltage, and a method for manufacturing the magnesium secondary battery.

In some embodiments, a magnesium secondary battery includes: a positive electrode; a negative electrode having a magnesium layer made of a eutectic magnesium alloy; a separator; and an electrolytic solution. In in powder X-ray diffraction measurement of the negative electrode using a CuKα ray, when an intensity ratio Y obtained from a diffraction peak representing a (100) plane within a range of 2θ=32°±5° and a diffraction peak representing a (002) plane within a range of 2θ=35°±5° is defined as a diffraction peak intensity ratio of (100)/(002), 15<Y is satisfied. Note that a diffraction peak intensity ratio may be simply referred to as “peak intensity ratio”.

When the magnesium secondary battery is used, internal short circuit can be suppressed even when a eutectic magnesium alloy is used. Therefore, it is possible to provide a magnesium secondary battery capable of suppressing occurrence of internal short circuit and reducing overvoltage.

In some embodiments, provided is a method for manufacturing a magnesium secondary battery including a positive electrode, a negative electrode having a magnesium layer made of a magnesium alloy, a separator, and an electrolytic solution. The method includes an activation step of performing charging and discharging at 5 mA/cm² or more.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exploded perspective view for explaining a structure of a magnesium secondary battery according to an embodiment of the disclosure.

### DETAILED DESCRIPTION

Hereinafter, a first embodiment of the disclosure will be described, but the disclosure is not limited to the following description. In addition, various changes or improvements can be added to the present embodiment, and a mode to which such changes or improvements are added can also be included in the disclosure.

A magnesium secondary battery in the disclosure includes a positive electrode, a separator, a negative electrode, an electrolytic solution, and an exterior body that houses the positive electrode, the separator, the negative electrode, and the electrolytic solution. The positive electrode and the negative electrode are disposed such that active materials thereof face each other, and the separator is present between the positive electrode and the negative electrode.

### Embodiment

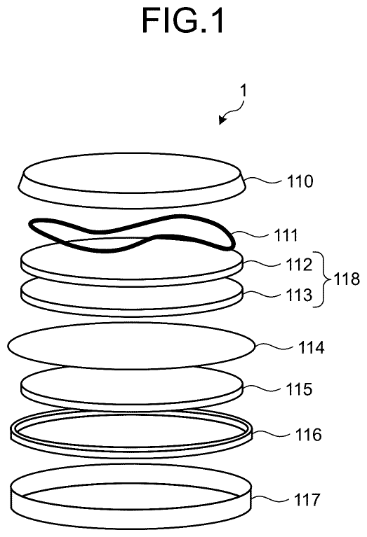

FIG. 1 is an exploded perspective view for explaining a structure of a magnesium secondary battery according to an embodiment of the disclosure. A magnesium secondary battery 1 includes a case 110, a leaf spring 111, a positive electrode current collector 112, a positive electrode mixture layer 113, a separator 114, a negative electrode 115, a gasket 116, and a cap 117. Note that the positive electrode current collector 112 and the positive electrode mixture layer 113 constitute a positive electrode 118. The disclosure is not limited to this mode, and a mode including a plurality of positive electrodes and a plurality of negative electrodes is also preferably used, and can also be used as a magnesium secondary battery formed by laminate pouch.

In the magnesium secondary battery 1, the case 110 and the cap 117 are fixed by crimping or the like, and an inside of the magnesium secondary battery 1 is filled with a nonaqueous electrolytic solution. The magnesium secondary battery 1 is liquid-tightly sealed by the case 110, the gasket 116, and the cap 117. The positive electrode current collector 112, the positive electrode mixture layer 113, the separator 114, and the negative electrode 115 are biased toward the cap 117 by the leaf spring 111. As a result, a state in which the members are in close contact with each other is maintained.

### Positive Electrode

An embodiment of the disclosure provides a positive electrode for a magnesium secondary battery (positive electrode 118) including at least a positive electrode current collector and a positive electrode mixture layer disposed on one side or both sides of the positive electrode current collector.

A material constituting the positive electrode current collector 112 is not particularly limited, but a metal is preferably used. Specific examples thereof include copper, aluminum, nickel, stainless steel, titanium, and an alloy. Among these metals, aluminum is preferable from a viewpoint of electron conductivity and battery operating potential.

A binder used for the positive electrode mixture layer 113 is, for example, one of polyethylene, polypropylene, an ethylene propylene terpolymer, a butadiene rubber, a styrene butadiene rubber, a butyl rubber, polytetrafluoroethylene, poly(meth)acrylate, polyvinylidene fluoride, polyethylene oxide, polypropylene oxide, polyepichlorohydrin, polyfachazene, and polyacrylonitrile, or a mixture thereof.

Examples of a positive electrode active material include MgCo₂O₄, MgFeSiO₄, S, MnO₂, Mo₆S₈, and V₂O₅. In order to improve electron conductivity, for example, one of conductive carbon powders such as graphite and carbon black, a carbon nanotube, a carbon nanofiber, and graphene, or a mixture thereof may be contained.

### Negative Electrode

An embodiment of the disclosure provides a negative electrode for a magnesium secondary battery (negative electrode 115) including at least a negative electrode current collector and a magnesium layer made of a magnesium metal material, disposed on one side or both sides of the negative electrode current collector. The negative electrode current collector does not have to be used.

A material constituting the negative electrode current collector is not particularly limited, but a metal is preferably used. Specific examples thereof include copper, aluminum, nickel, stainless steel, titanium, and an alloy. Among these metals, copper is preferable from a viewpoint of electron conductivity and battery operating potential.

The magnesium metal material is a eutectic magnesium metal alloy. In particular, the magnesium metal material is preferably a magnesium alloy containing 3% or more by weight of other metals as the magnesium layer. This is because the magnesium alloy is affected by a method for controlling an electrode surface state described later more strongly than a simple substance of magnesium. Furthermore, a magnesium metal alloy negative electrode having a eutectic crystal structure in which two phases of a hexagonal close-packed (hcp) structure and a body-centered cubic (bcc) structure coexist is preferable. The magnesium metal material is more preferably a magnesium metal alloy containing lithium in a range of 6% by weight or more and 10.5% by weight or less. A reason why the negative electrode according to the present embodiment is preferably used is considered to be that since the bcc structure has a lower atom filling ratio than the hcp structure, magnesium ions are smoothly inserted into and extracted from a bulk, and as a result, charging and discharging characteristics are improved, and overvoltage at the time of dissolution and precipitation of magnesium is reduced. When a negative electrode other than the negative electrode of the disclosure is used, it is difficult to insert and extract magnesium ions into and from a bulk, and favorable charging and discharging characteristics cannot be necessarily obtained.

Note that, in the present specification, the eutectic state includes a hypo-eutectic state and a hyper-eutectic state, and means that two or more kinds of crystal structures can be confirmed.

When the magnesium metal material is in a eutectic state, there is a peak attributed to a (220) plane derived from a bcc structure in which 2θ exists in a range of 65° to 66° in addition to a peak derived from an hcp structure in an X-ray diffraction pattern obtained by X-ray diffraction measurement using a Cu-Kα ray.

In the present embodiment, the magnesium metal material is characterized in that, in powder X-ray diffraction measurement, when an intensity ratio Y obtained from a diffraction peak representing a (100) plane within a range of 2θ=32°±5° and a diffraction peak representing a (002) plane within a range of 2θ=35°±5° is defined as a diffraction peak intensity ratio of (100)/(002), 15<Y is satisfied. A reason why the negative electrode according to the present embodiment is preferably used is that when a eutectic magnesium metal alloy negative electrode is used as the negative electrode, internal short circuit can be suppressed. A cause of the internal short circuit is as follows. First, when the eutectic magnesium metal alloy negative electrode is used, different crystal structures are mixed. Therefore, an electrochemically active surface is partially exposed in the vicinity of a grain boundary where the different crystal structures are adjacent to each other on an electrode surface. Therefore, current concentration occurs at a portion where the active surface is partially exposed, and magnesium to be electrodeposited at the portion is precipitated in a tower shape. Therefore, an electrodeposited product penetrates the separator to cause internal short circuit. This is a problem that does not occur in other magnesium metal negative electrodes. In order to solve this problem, a eutectic magnesium metal alloy negative electrode having a peak intensity ratio Y of (100)/(002) plane of 15<Y in X-ray diffraction measurement is used.

Here, a crystal structure of magnesium will be described. (001) and (002) plane orientations in which an orientation plane of magnesium is a bottom surface portion are electrochemically inactive planes. On the other hand, (101) and (110) plane orientations derived from a side surface portion are electrochemically active planes. Note that it is known that the (110) plane is more electrochemically active than the (001) plane (See, for example, C. Ling et al, electrochmica Acta 76 (2012), 270-274). Together with the (001) plane, the (002) plane indicating orientation of a bottom surface portion of magnesium is also more inactive than (110).

Here, the peak intensity of the (100) plane has a positive correlation with the peak intensities of the (101) and (110) planes, and expresses the peak intensities of the (101) and (110) planes. The intensity ratio Y is set on the basis of a value activated at a current density (5 mA/cm²) known as a boundary of activation of magnesium, and is set to 15<Y in the present embodiment. In addition, 15<Y<30 is more preferable, and 15<Y<20 is still more preferable.

When a magnesium metal alloy negative electrode in which the peak intensity ratio Y of the (100)/(002) plane is 15<Y is used, many active surfaces are present on an electrode surface. As a result, the active surface of magnesium increases, uneven precipitation of magnesium to be electrodeposited in a tower shape can be suppressed, and internal short circuit can be suppressed. On the other hand, when a magnesium metal alloy negative electrode in which the peak intensity ratio Y of the (100)/(002) plane is Y≥30 is used, overvoltage increases during an activation step, and activation cannot be performed in some cases.

By using a eutectic magnesium metal alloy having a surface state in which the peak intensity ratio Y of the (100)/(002) plane is 15<Y, many active surfaces are present on an electrode surface, and thus magnesium ions are more smoothly moved. As a result, it is possible to reduce overvoltage at the time of dissolution and precipitation of magnesium.

Usual magnesium metal negative electrodes including a eutectic magnesium metal alloy negative electrode that has just been completed as an alloy do not satisfy a condition that the peak intensity ratio Y of the (100)/(002) plane is 15<Y. Therefore, in order to control an electrode surface state as in the above magnesium metal alloy negative electrode, an activation step was performed on a eutectic magnesium metal alloy negative electrode. At this time, when constant current charging and discharging is performed at a low current density, for example, less than 5 mA/cm², magnesium to be electrodeposited is a particle having many bottom surface portions ((001) plane and (002) plane) which are thermodynamically stable crystal planes. On the other hand, by performing constant current charging and discharging at a high current density, a particle having many thermodynamically unstable side surface portions ((110) plane and (100) plane) is electrodeposited. That is, by performing a manufacturing method including an activation step in which a current density is controlled, it is possible to prepare a magnesium metal alloy negative electrode in which the peak intensity ratio Y of the (100)/(002) plane is 15<Y.

The peak intensity ratio Y of the (100)/(002) plane can be adjusted by, for example, a current density during the activation step. At this time, when the current density is 5 mA/cm² or more (hereinafter, also referred to as a high current density), large orientation occurs on a surface of electrodeposited magnesium in the electrochemically active side surface portion ((110) plane or (100) plane), and the intensity ratio Y also increases. Note that, when the current density is excessively increased, overvoltage increases, and constant current charging and discharging is impossible. Therefore, the current density is preferably less than 20 mA/cm², more preferably less than 15 mA/cm², and still more preferably less than 10 mA/cm².

Here, for example, a magnesium alloy containing 9% by weight of lithium (for example, LZ91) is a eutectic magnesium alloy, and therefore magnesium to be electrodeposited is local. Furthermore, when charging and discharging are performed at a low current density, the active surface of magnesium to be electrodeposited is small. Therefore, magnesium is electrodeposited in a part thereof in a concentrated manner and is formed in a tower shape, which may penetrate the separator to cause short circuit. Therefore, by performing charging and discharging at a high current density, magnesium to be electrodeposited is largely orientated on an active surface and precipitated in a multifaceted manner. Therefore, electrodeposition in a tower shape is suppressed, and short circuit is suppressed.

Note that examples of a metal that can be brought into a eutectic state in the magnesium alloy include scandium and strontium in addition to lithium. Since lithium is cheaper, lithium is industrially desirable. In addition, a eutectic state of a crystal structure is a eutectic state of two or more structures selected from, for example, an hcp structure, a bcc structure, and a face-centered cubic (fcc) structure depending on a substitution metal. A eutectic state derived from magnesium and lithium is a eutectic state of the hcp structure and the bcc structure.

### Electrolytic Solution

A magnesium salt contained in the nonaqueous electrolytic solution is, for example, one selected from MgCl₂, MgBH₄, Mg(NO₃)₂, Mg(TFSI)₂, Mg(SO₂CF₃)₂, Mg(BF₄)₂, Mg(CF₃SO₃)₂, and Mg(PF₆)₂, or a mixture of two or more types thereof, but are not necessarily limited thereto.

A nonaqueous solvent contained in the nonaqueous electrolytic solution is not particularly limited, and is, for example, one selected from dimethyl carbonate (DMC), diethyl carbonate (DEC), dipropyl carbonate (DPC), ethyl methyl carbonate (EMC), ethylene carbonate (EC), propylene carbonate (PC), methyl propionate, methyl acetate, methyl formate, methyl butyrate, dioxolane, 2-methyltetrahydrofuran, tetrahydrofuran, dimethoxyethane, Y-butyrolactone, acetonitrile, benzonitrile, diethylene glycol dimethyl ether (diglyme), triethylene glycol dimethyl ether (triglyme), tetraglyme dimethyl ether (tetraglyme), and sulfolane, or a mixture of two or more types thereof. Separator

Examples of the separator include a porous sheet separator made of a polymer or a fiber, and a nonwoven fabric separator.

In the present embodiment, in the magnesium secondary battery 1, the leaf spring 111, the positive electrode current collector 112, the positive electrode mixture layer 113, the separator 114, the negative electrode 115, and the gasket 116 are arranged in this order, then these are sandwiched between the case 110 and the cap 117, a nonaqueous electrolytic solution is filled thereinto, the case 110 and the cap 117 are fixed by crimping or the like to liquid-tightly seal the magnesium secondary battery 1, and then the activation step is performed. In this activation step, it is preferable to perform charging at a current density of 5 mA/cm² or more. At this time, it is preferable to perform ten cycles or more, in which one cycle includes performing charging for one hour or more and performing discharging for one hour or more at a current density of 5 mA/cm² or more. In addition, as an upper limit of voltage at the time of charging, it is desirable to perform the activation step while keeping a state of charge (SOC), which is a state of charging of a battery, at 2% or more and 10% or less. A maximum charging state may be 2% or more and 10% or less in one cycle, but the maximum charging state is more preferably 2% or more and 10% or less in all cycles. As a result, it is possible to reliably obtain a negative electrode having the above-described peak intensity ratio Y >15.

### Examples

Hereinafter, the disclosure will be described in more detail by exemplifying Examples, but the disclosure is not limited to the following modes at all.

### Level 1

### Constant Current Test

In Level 1, a constant current test was performed on a symmetric cell using a magnesium alloy containing 9% by weight of lithium as an electrode, using a polyethylene separator as a separator, using an electrolytic solution obtained by adding LiBH₄ as an additive to Mg(TSFA)₂/G2 (diethyleneglycol dimethyl ether) as an electrolytic solution, and using a laminated exterior body as an exterior body. As measurement conditions, 100 cycles were performed, in which one cycle includes performing charging for one hour at 1 mA/cm² and performing discharging for one hour at 1 mA/cm², and a measurement temperature was room temperature (25° C.).

### Activation Step

Using the above cell, before the constant current test was performed, as an activation step, an activation step of performing ten cycles was performed, in which one cycle includes performing charging for one hour at 5 mA/cm² and performing discharging for one hour at 5 mA/cm².

Test results in Level 1 are presented in Table 1.

TABLE 1

| | Activation | | | | | Number of | |
|---|---|---|---|---|---|---|---|
| | current | | | | Overvoltage | cycles at time | |
| | value | Activation | SOC | | after one | of internal | |
| | (mA/cm²) | time (h) | (%) | Y | cycle (V) | short circuit | |
| Level 1 | 5 | 1 | 4.540 | 15.90 | 0.01 | No internal | |
| | | | | | | short circuit | |
| Level 2 | 10 | 1 | 9.100 | 24.10 | 0.01 | No internal | |
| | | | | | | short circuit | |
| Level 3 | 5 | 0.5 | 2.280 | 15.10 | 0.05 | No internal | |
| | | | | | | short circuit | |
| Level 4 | 4 | 1 | 3.632 | 12.50 | 0.08 | 49 | cycles |
| Level 5 | 1 | 1 | 0.908 | 5.61 | 0.20 | 10 | cycles |
| Level 6 | 5 | 0.4 | 1.816 | 11.60 | 0.12 | 52 | cycles |
| Level 7 | 5 | 2.5 | 11.350 | 35.60 | — | 1 | cycle |
| Level 8 | 20 | 1 | 18.180 | Activation | Activation | Activation | |
| | | | | was | was | was | |
| | | | | impossible | impossible | impossible | |
| | | | | because of | because of | because of | |
| | | | | large | large | large | |
| | | | | overvoltage | overvoltage | overvoltage | |
| Level 9 | None | None | None | 1.19 | 0.20 | 5 | cycles |

### Level 2

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 10 mA/cm² and performing discharging for one hour at 10 mA/cm². Test results in Level 2 are presented in Table 1.

### Level 3

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 0.5 hours at 5 mA/cm² and performing discharging for 0.5 hours at 5 mA/cm². Test results in Level 3 are presented in Table 1.

### Level 4

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 4 mA/cm² and performing discharging for one hour at 4 mA/cm². Test results in Level 4 are presented in Table 1.

### Level 5

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 1 mA/cm² and performing discharging for one hour at 1 mA/cm². Test results in Level 5 are presented in Table 1.

### Level 6

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 0.4 hours at 5 mA/cm² and performing discharging for 0.4 hours at 5 mA/cm². Test results in Level 6 are presented in Table 1.

### Level 7

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 2.5 hours at 5 mA/cm² and performing discharging for 2.5 hours at 5 mA/cm². Test results in Level 7 are presented in Table 1.

### Level 8

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 20 mA/cm² and performing discharging for one hour at 20 mA/cm². Test results in Level 8 are presented in Table 1.

Level 9 A structure of a battery is similar to that of Level 1. As a test method, a test was performed under similar conditions to Level 1 except for the activation step. In addition, the activation step was not performed. Test results in Level 9 are presented in Table 1.

From Table 1, in Levels 1 to 3 where Y was 15 or more and 30 or less, overvoltage after one cycle was 0.05 V or less, which was favorable, and favorable results without occurrence of internal short circuit were obtained. In

Levels 1 to 3 and 6 including the activation step of performing charging at 5 mA/cm² or more, overvoltage after one cycle was 0.12 V or less, which was favorable, and the number of cycles at the time of internal short circuit was at least 52 cycles, which was a favorable value. On the other hand, in Level 5 where Y was less than 15 and in Level 9 where the activation step was not performed, overvoltage after one cycle was 0.20 V, and the number of cycles at the time of internal short circuit was 10 cycles or less, which were unpreferable results. In Level 7 where Y was more than 30, internal short circuit occurred early, and in Level 8 where an activation current value was high, the activation step itself was impossible. From the above results, it is possible to provide a magnesium secondary battery capable of reducing overvoltage by using a eutectic magnesium alloy which is an electrochemically active material for a negative electrode, and capable of suppressing occurrence of internal short circuit and reducing overvoltage by controlling an electrode surface state.

According to the disclosure, in the magnesium secondary battery, occurrence of internal short circuit can be suppressed while overvoltage is reduced.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnesium secondary battery comprising:
a positive electrode;
a negative electrode having a magnesium layer made of a eutectic magnesium alloy;
a separator; and
an electrolytic solution, wherein
in powder X-ray diffraction measurement of the negative electrode using a Cukα ray, when an intensity ratio Y obtained from a diffraction peak representing a (100) plane within a range of 2θ=32°±5° and a diffraction peak representing a (002) plane within a range of 2θ=35°±5° is defined as a diffraction peak intensity ratio of (100)/(002), 15<Y is satisfied.

2. The magnesium secondary battery according to claim 1, wherein
the magnesium alloy has a crystal structure in which a hexagonal closest-packed structure and a body-centered cubic structure are in a eutectic state.

3. The magnesium secondary battery according to claim 2, wherein
the magnesium alloy contains lithium in a range of 6% by weight or more and 10.5% by weight or less.

4. A method for manufacturing a magnesium secondary battery including a positive electrode, a negative electrode having a magnesium layer made of a magnesium alloy, a separator, and an electrolytic solution, the method comprising
an activation step of performing charging and discharging at 5 mA/cm² or more.

5. The method for manufacturing a magnesium secondary battery according to claim 4, wherein one charging and discharging cycle in which charging is performed for one hour or more and discharging is performed for one hour or more is performed for ten cycles or more.

6. The method for manufacturing a magnesium secondary battery according to claim 4, further comprising one charging and discharging cycle in which an upper limit of SOC during charging is 2% or more and 10% or less.

7. The method for manufacturing a magnesium secondary battery according to claim 4, wherein a negative electrode having a magnesium layer made of a magnesium alloy containing 3% by weight or more of other metals is used.

8. The method for manufacturing a magnesium secondary battery according to claim 4, wherein a negative electrode having a magnesium layer made of a eutectic magnesium alloy is used.
